(19) United States
(12) Patent Application Publication
(10) Pub. No.: US 2015/0174744 A1
(43) Pub. Date: Jun. 25, 2015

(54) IMPACT TOOL

(71) Applicants: Techtronic Industries Co. Ltd., Tsuen Wan (HK); Milwaukee Electric Tool Corporation, Brookfield, WI (US)

(72) Inventors: Zachary Scott, Easley, SC (US); John S. Scott, Brookfield, WI (US)

(21) Appl. No.: 14/640,690

(22) Filed: Mar. 6, 2015

Related U.S. Application Data
(63) Continuation-in-part of application No. 13/293,462, filed on Nov. 10, 2011, now Pat. No. 9,016,395.
(60) Provisional application No. 61/414,296, filed on Nov. 16, 2010.

(51) Int. Cl. B25B 21/02

(52) U.S. Cl. CPC B25B 21/02

(57) ABSTRACT

An impact tool includes a housing, a motor supported in the housing and defining a first axis, an output shaft rotatably supported in the housing about a second axis oriented substantially normal to the first axis, an impact mechanism coupled between the motor and the output shaft and operable to impart a striking force in a rotational direction to the output shaft, and a battery electrically connected to the motor and oriented along a third axis substantially parallel with and offset from the first axis.

### CROSS-REFERENCE TO RELATED APPLICATIONS

This application is a continuation-in-part of co-pending U.S. patent application Ser. No. 13/293,462 filed on Nov. 10, 2011, which claims priority to U.S. Provisional Patent Application No. 61/414,296 filed on Nov. 16, 2010, the entire contents of both of which are incorporated herein by reference.

### FIELD OF THE INVENTION

The present invention relates to tools, and more particularly to power tools.

### BACKGROUND OF THE INVENTION

Impact tools or wrenches are typically utilized to provide a striking rotational force, or intermittent applications of torque, to a tool element and workpiece (e.g., a fastener) to either tighten or loosen the fastener. Conventional impact wrenches (i.e., either pneumatic or battery-powered) typically include a pistol grip-style housing having a handle portion grasped by the operator of the impact wrench and a motor portion extending from the handle portion. As a result of such a configuration, conventional impact wrenches are often difficult to maneuver within small work spaces.

### SUMMARY OF THE INVENTION

The invention provides, in one aspect, an impact tool including a housing, a motor supported in the housing and defining a first axis, an output shaft rotatably supported in the housing about a second axis oriented substantially normal to the first axis, an impact mechanism coupled between the motor and the output shaft and operable to impart a striking force in a rotational direction to the output shaft, and a battery electrically connected to the motor and oriented along a third axis substantially parallel with and offset from the first axis.

Other features and aspects of the invention will become apparent by consideration of the following detailed description and accompanying drawings.

### BRIEF DESCRIPTION OF THE DRAWINGS

FIG. 1 is a front perspective view of an impact tool according to an embodiment of the invention.

FIG. 2 is a side view of the impact tool of FIG. 1.

FIG. 3 is an exploded perspective view of the impact tool of FIG. 1.

FIG. 4 is a cross-sectional view of the impact tool of FIG. 1 through line 4-4 in

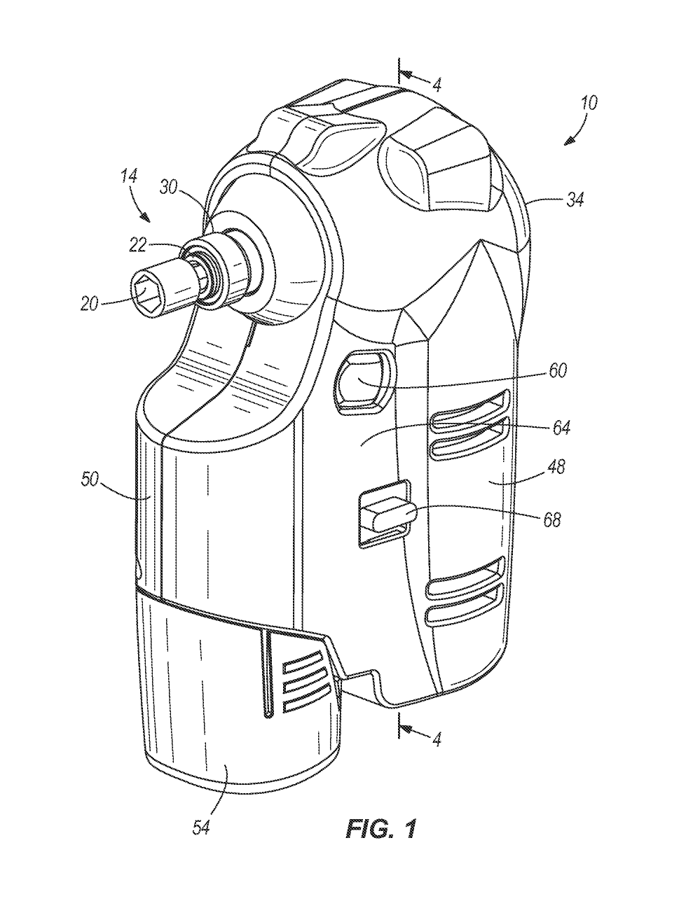

FIG. 1.

FIG. 5 is a front perspective view of an impact tool according to a second embodiment of the invention.

FIG. 6 is a side view of the impact tool of FIG. 5.

FIG. 7 is an exploded perspective view of the impact tool of FIG. 5.

FIG. 8 is a cross-sectional view of the impact tool of FIG. 5 through line 8-8 in

FIG. 5.

FIG. 9 is an exploded perspective view of a portion of an impact tool according to a third embodiment of the invention.

FIG. 10 is an assembled, cross-sectional view of a portion of the impact tool of FIG. 9.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

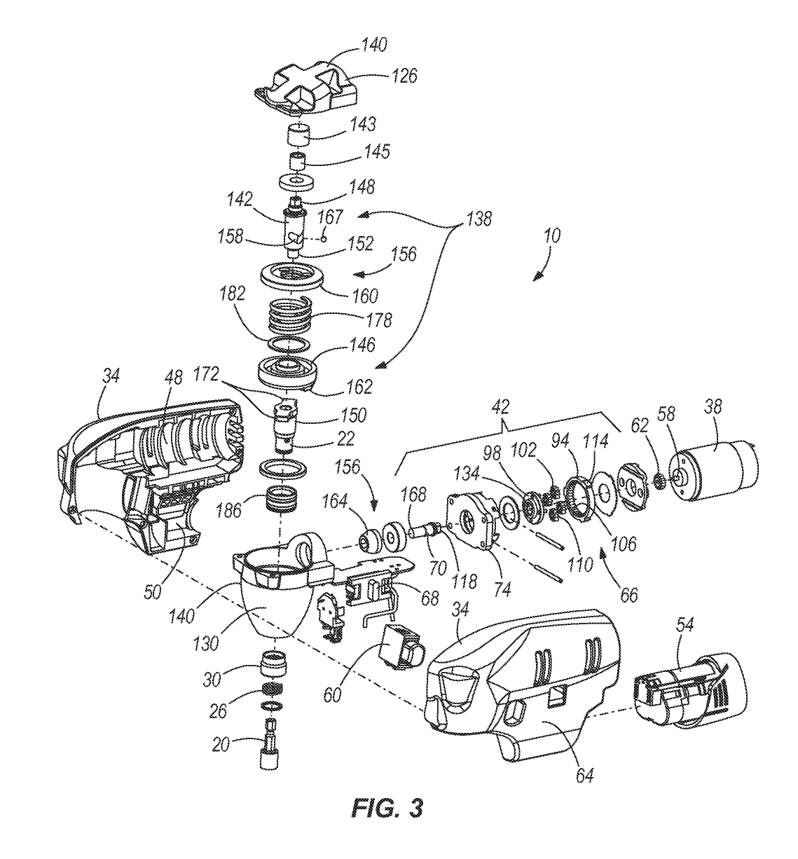

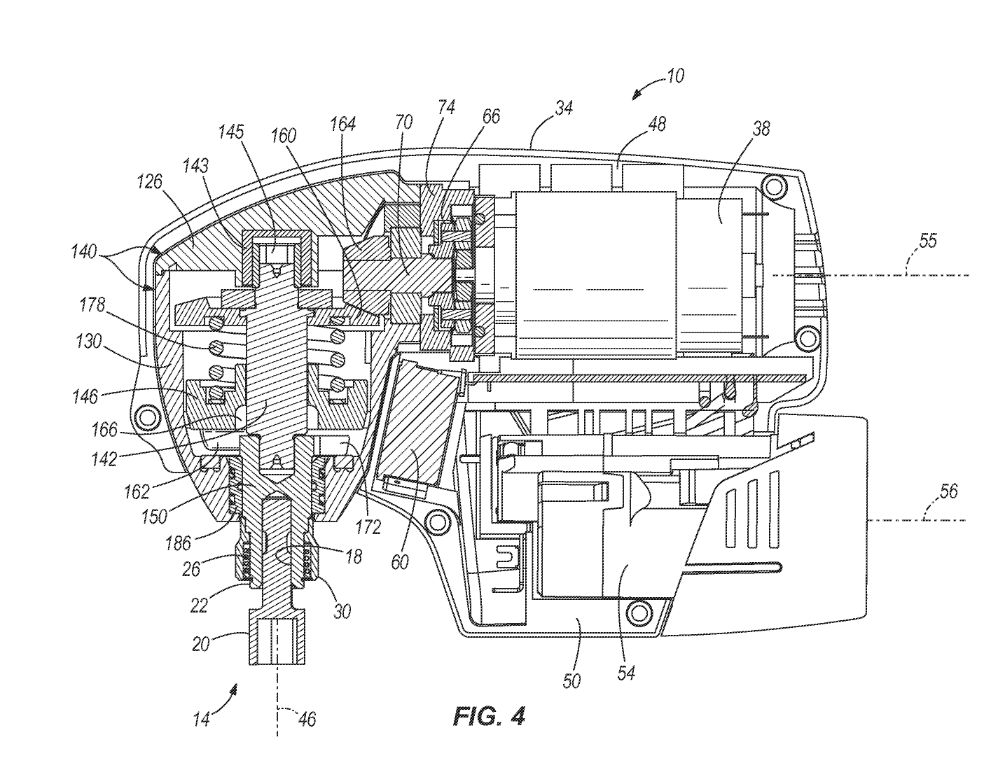

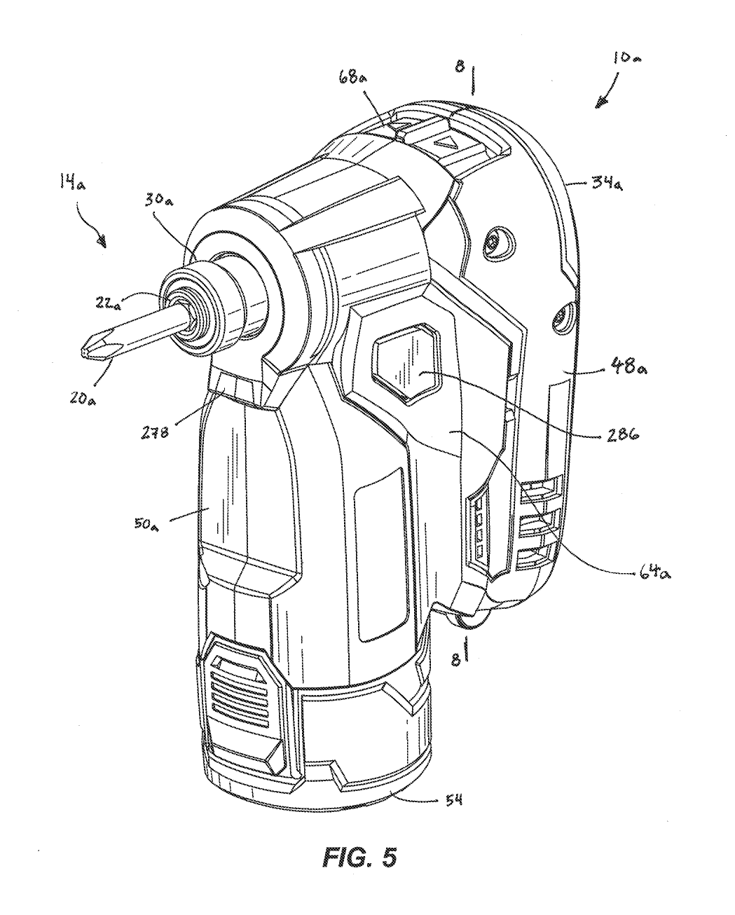

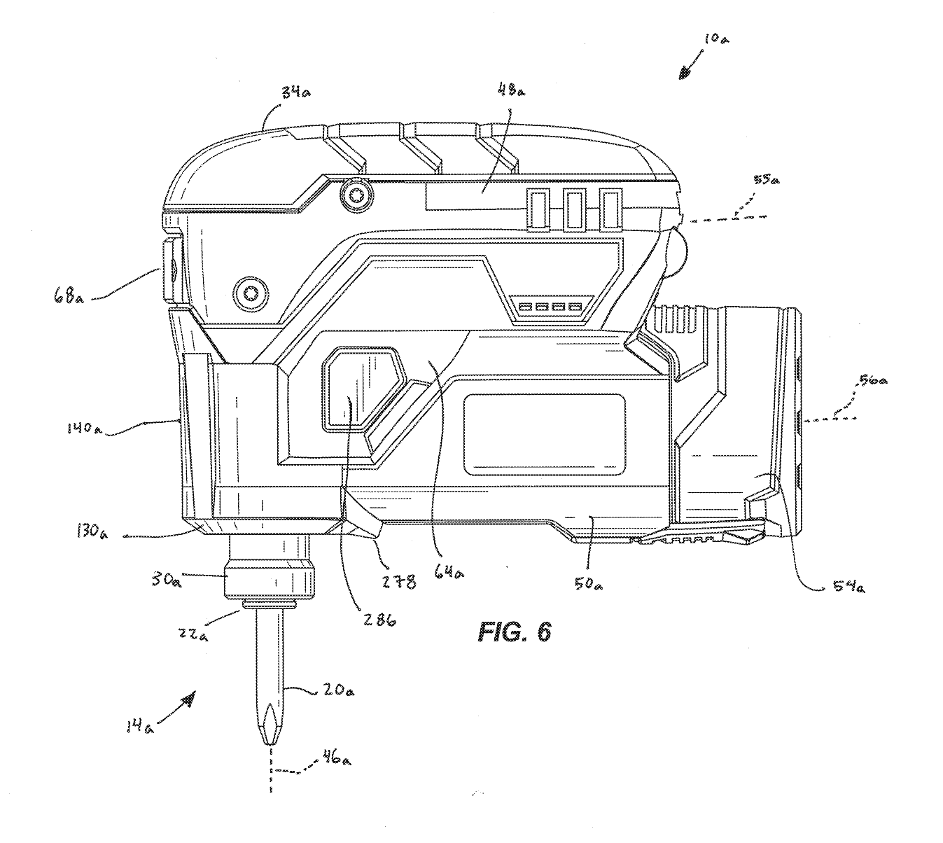

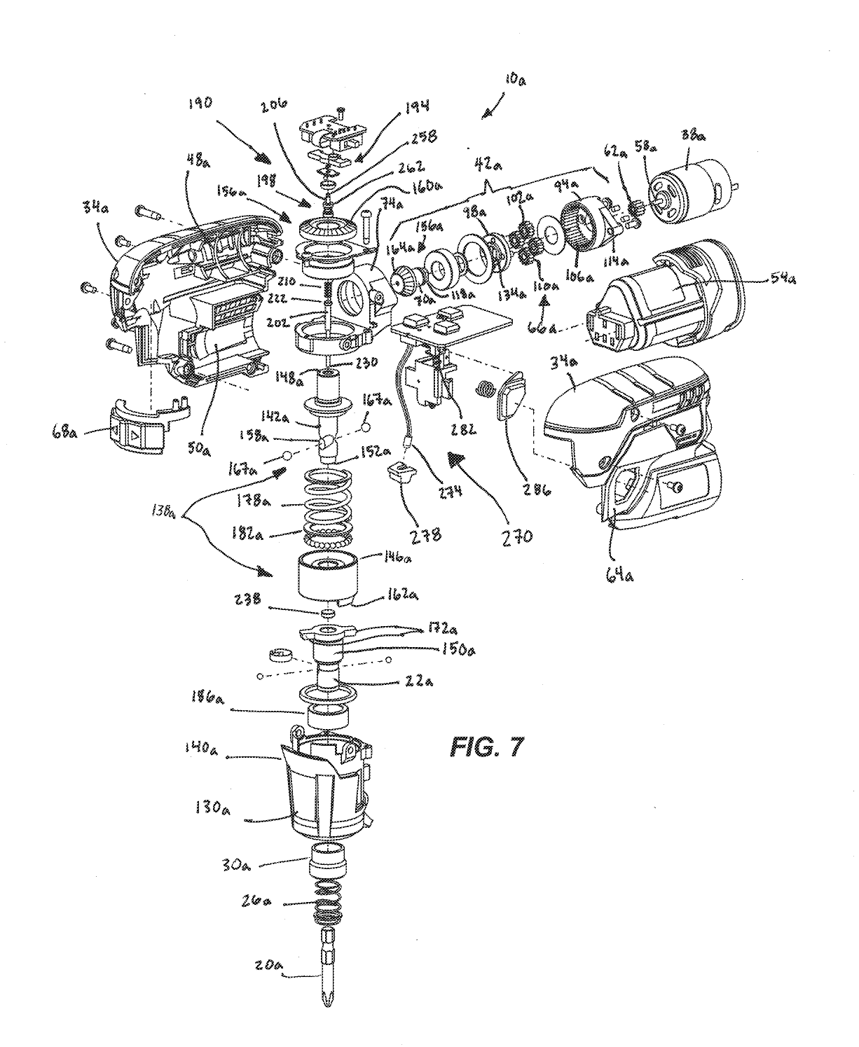

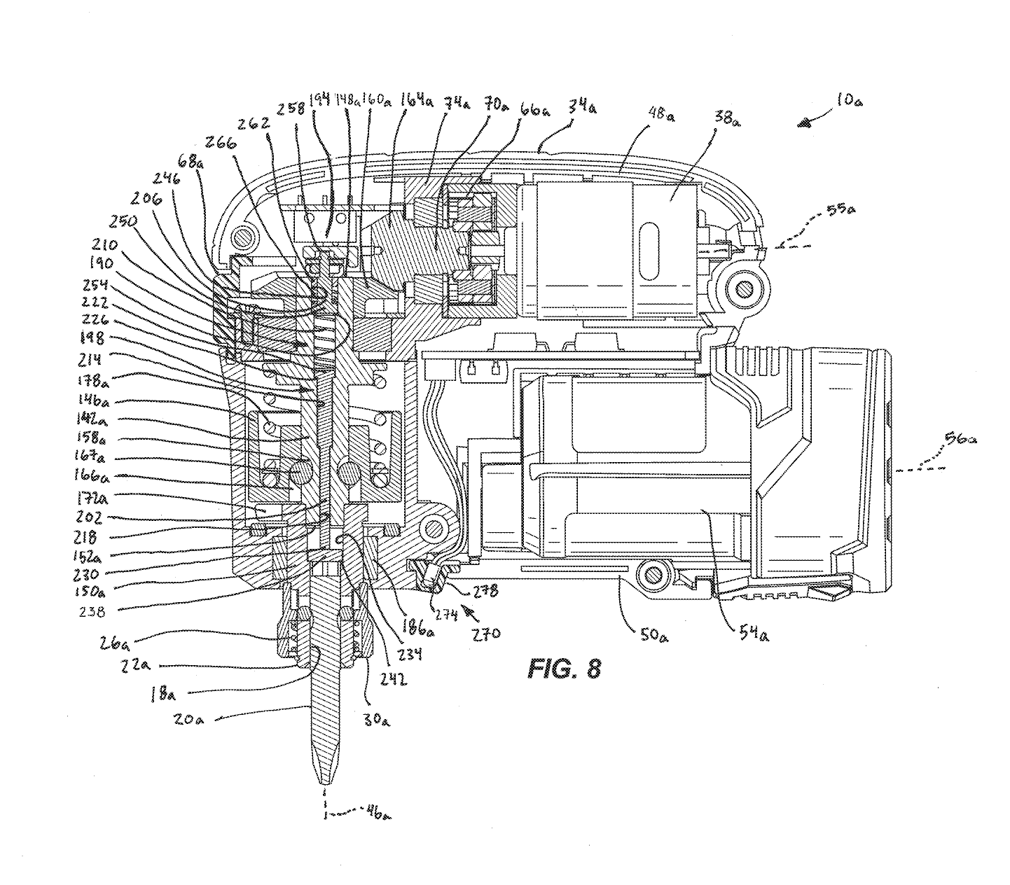

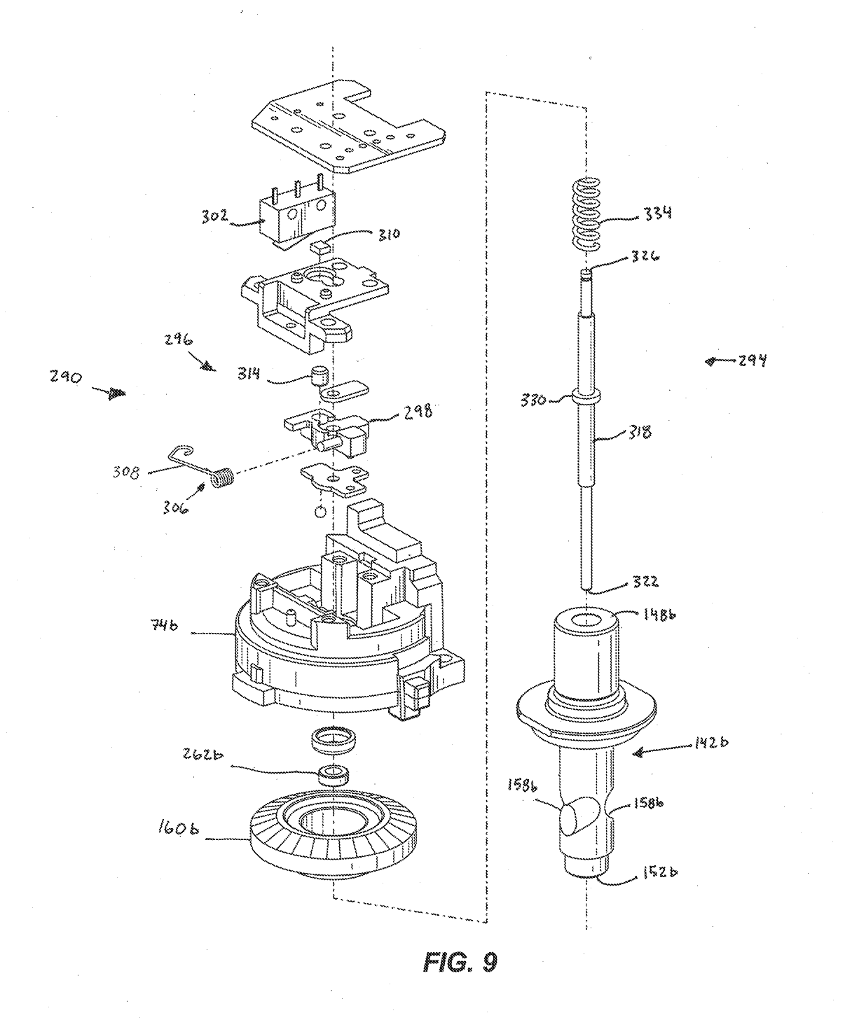

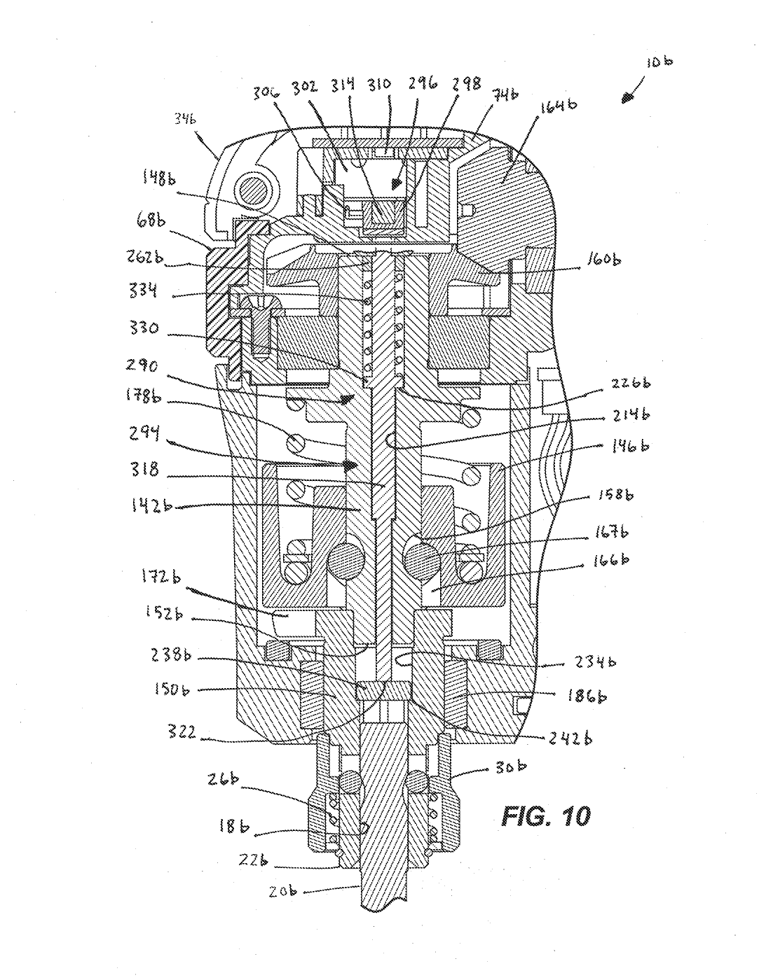

FIGS. 1-4 illustrate a first embodiment of an impact tool 10 including a drive end 14 having a non-cylindrical bore 18 (FIG. 4) within which a fastener, a tool bit, or a driver bit 20 may be received. In the illustrated construction of the tool 10, the non-cylindrical bore 18 includes a hexagonal cross-sectional shape. However, the non-cylindrical bore 18 may be shaped in any of a number of different ways to receive any of a number of different fasteners, tool bits, and/or driver bits 20. The drive end 14 includes an output shaft 22 (FIG. 3) having a detent (not shown) utilized to lock or axially secure the fastener, tool bit, and/or driver bit 20 to the drive end 14 of the tool 10, a sleeve 30 positioned over the output shaft 22 for actuating the detent between a locked and an unlocked configuration, and a biasing member (e.g., a compression spring 26) for biasing the sleeve 30 toward a position in which the detent is in the locked configuration. Alternatively, the detent, the sleeve 30, and the spring 26 may be omitted from the output shaft 22, such that the fastener, tool bit, and/or driver bit 20 is not lockable to the drive end 14 of the tool 10.

With reference to FIG. 4, the impact tool 10 includes a housing 34, a motor 38 supported in the housing 34, and a transmission 42 (FIG. 3) operably coupled to the motor 38 to receive torque from the motor 38. The output shaft 22 is rotatable about an axis 46 and operably coupled to the transmission 42 to receive torque from the transmission 42.

In the illustrated construction of the tool 10, the housing 34 includes a motor support portion 48 in which the motor 38 is contained, and a battery support portion 50 in which a battery pack 54 is removably received. The battery pack 54 is located directly below the motor 38 from the frame of reference of FIG. 4, such that the motor 38 and the battery pack 54 define respective parallel axes 55, 56. As is discussed below, the motor support portion 48 is grasped by the user of the tool 10 during operation. Because of the positioning of the battery pack 54 relative to the motor 38 within the housing 34, the motor 38 and the battery pack 54 substantially fit within the envelope of the user's wrist to facilitate maneuverability of the tool 10 in small work spaces. In other words, the impact tool 10 is sufficiently compact to permit the user to maneuver the tool 10 throughout the range of motion of the user's wrist without the housing 34 or the battery pack 54 interfering with the user's arm.

The battery pack 54 is electrically connected to the motor 38 via a variable-speed trigger switch 60 to provide power to the motor 38. As shown in FIG. 4, the trigger switch 60 is located on a side wall 64 of the housing 34 between the respective axes 55, 56 of the motor 38 and battery pack 54 to provide ergonomic access to the trigger switch 60 while the user is grasping the motor support portion 48 of the housing 34. The battery pack 54 is a 12-volt power tool battery pack 54 and includes three lithium-ion battery cells. Alternatively, the battery pack 54 may include fewer or more battery cells to yield any of a number of different output voltages (e.g., 14.4 volts, 18 volts, etc.). Additionally or alternatively, the battery cells may include chemistries other than lithium-ion such as, for example, nickel cadmium, nickel metal-hydride, or the like. Alternatively, the tool 10 may include an electrical cord for connecting the motor 38 to a remote electrical source (e.g., a wall outlet).

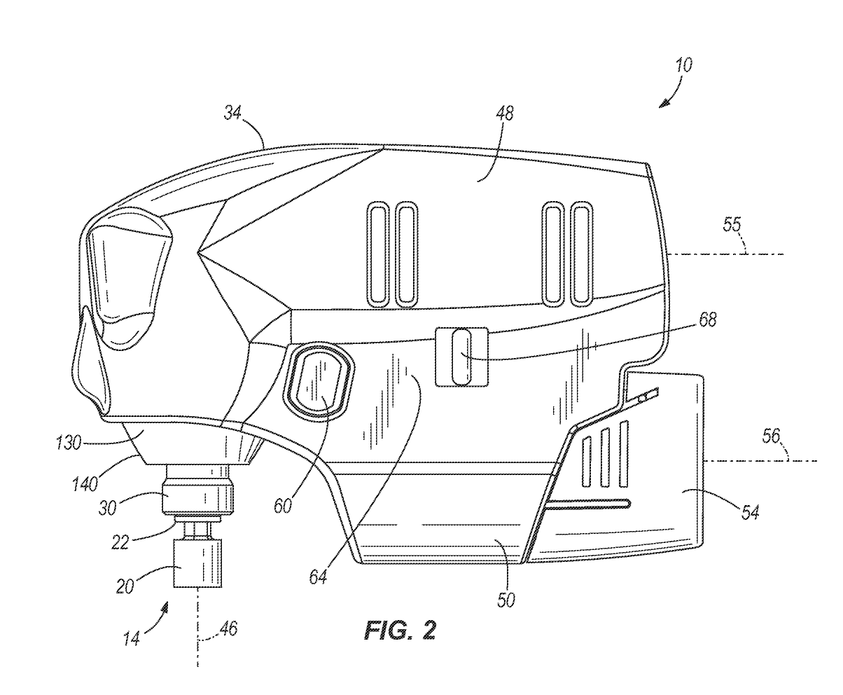

The tool 10 also includes a direction switch 68 (FIGS. 1 and 2) that is toggled between a first position, in which the motor 38 is activated to rotate the output shaft 22 in a forward (i.e., clockwise) direction, and a second position, in which the motor 38 is activated to rotate the output shaft 22 in a reverse (i.e., counter-clockwise) direction.

The motor 38 is configured as a direct-current, can-style motor 38 having a motor output shaft 58 upon which a pinion 62 is fixed for rotation (FIG. 3). In the illustrated construction of the tool 10, the pinion 62 is interference or press-fit to the motor output shaft 58. Alternatively, the pinion 62 may be coupled for co-rotation with the motor output shaft 58 in any of a number of different ways (e.g., using a spline fit, a key and keyway arrangement, by welding, brazing, using adhesives, etc.). As a further alternative, the pinion 62 may be integrally formed as a single piece with the motor output shaft 58.

With reference to FIGS. 3 and 4, the transmission 42 includes a single stage planetary transmission 66 and a transmission output shaft 70 functioning as the rotational output of the transmission 42. The transmission 42 also includes a gear case 74 within which the planetary transmission 66 is received. The gear case 74 is fixed to the motor 38 (e.g., using fasteners), and the combination of the gear case 74 and the motor 38 is clamped between the opposite halves of the housing 34 (FIG. 3).

With continued reference to FIG. 3, the planetary transmission 66 includes an outer ring gear 94, a carrier 98 rotatable about the motor axis, and planet gears 102 rotatably coupled to the carrier 98 about respective axes radially spaced from the motor axis 55. The outer ring gear 94 includes radially inwardly-extending teeth 106 that are engageable by corresponding teeth 110 on the planet gears 102. The outer ring gear 94 also includes radially outwardly-extending protrusions 114, and the gear case 74 includes corresponding slots (not shown) within which the protrusions 114 are received to rotationally fix the outer ring gear 94 to the gear case 74, and therefore the housing 34. Alternatively, the outer ring gear 94 may be fixed to the gear case 74 in any of a number of different ways (e.g., using snap-fits, an interference or press-fit, fasteners, adhesives, by welding, etc.) As a further alternative, the outer ring gear 94 may be integrally formed as a single piece with the gear case 74.

The carrier 98 includes an aperture 134 having a non-circular cross-sectional shape (e.g., a “double-D”) corresponding to that of a first end 118 of the transmission output shaft 70 (FIG. 3). As such, the first end 118 of the transmission output shaft 70 is received within the aperture 134 and co-rotates with the carrier 98 at all times in response to activation of the motor 38. Alternatively, the transmission output shaft 70 may be non-rotatably coupled to the carrier 98 in any of a number of different ways.

With continued reference to FIG. 3, the tool 10 includes an impact mechanism 138 including an impact mechanism housing 140 clamped between the opposed halves of the tool housing 34 and a drive shaft 142 supported for rotation within the housing 140. In the illustrated construction of the tool 10, the housing 140 includes an upper housing portion 126 and a lower housing portion 130 interconnected to the upper housing portion 126 (e.g., using fasteners, etc.). The upper housing portion 126 includes a support 143 in which a needle bearing 145 is received (FIG. 4). A cylindrical first end 148 of the drive shaft 142 is supported by the needle bearing 145 for rotation relative to the housing 140. An opposite, second end 152 of the drive shaft 142 is piloted or supported for rotation relative to the housing 140 by the output shaft 22.

With reference to FIGS. 3 and 4, the impact tool 10 also includes a right-angle bevel gear arrangement 156 coupled between the motor 38 and the drive shaft 142. Particularly, the bevel gear arrangement 156 includes a bevel ring gear 160 coupled for co-rotation with the drive shaft 142 and a bevel pinion gear 164 engaged with the bevel ring gear 160 and coupled for co-rotation with a second end 168 of the transmission output shaft 70 (e.g., using an interference fit, a key and keyway arrangement, etc.). As shown in FIG. 4, the bevel pinion gear 164 is coaxial with the motor axis 55, and the bevel ring gear 160 is coaxial with the axis 46 of the output shaft 22. As such, the respective axes 55, 46 of the motor 38 and the output shaft 22 are oriented substantially normal to each other (i.e., at a right or 90-degree angle).

With reference to FIGS. 3 and 4, the impact mechanism 138 further includes a hammer 146 supported on the drive shaft 142 for rotation with the shaft 142, and an anvil 150 coupled for co-rotation with the output shaft 22. In the illustrated construction of the tool 10, the anvil 150 is integrally formed with the output shaft 22 as a single piece and includes opposed, radially outwardly extending lugs 172 (FIG. 3).

The shaft 142 includes two V-shaped cam grooves 158 (only one of which is shown in FIG. 3) equally spaced from each other about the outer periphery of the shaft 142. Each of the cam grooves 158 includes two segments that are inclined relative to the axis 46 in opposite directions. The hammer 146 has opposed lugs 162 and two cam grooves 166 (FIG. 4) equally spaced from each other about an inner periphery of the hammer 146. Like the cam grooves 158 in the shaft 142, each of the cam grooves 166 is inclined relative to the axis 46. The respective pairs of cam grooves 158, 166 in the shaft 142 and the hammer 146 are in facing relationship such that a cam member (e.g., a ball 167, see FIG. 3) is received within each of the pairs of cam grooves 158, 166. The balls 167 and the cam grooves 158, 166 effectively provide a cam arrangement between the shaft 142 and the hammer 146 for transferring torque between the shaft 142 and the hammer 146 between consecutive impacts of the lugs 162 upon the corresponding lugs 172 on the anvil 150. The impact mechanism 138 also includes a compression spring 178 positioned between the hammer 146 and the bevel ring gear 160 to bias the hammer 146 toward the anvil 150. A thrust bearing 182 is positioned between the hammer 146 and the spring 178 to permit relative rotation between the spring 178 and the hammer 146.

As previously discussed, the second end 152 of the drive shaft 142 is piloted or supported for rotation by the combination of the anvil 150 and the output shaft 22 (FIG. 4). The anvil 150, in turn, is supported for rotation within the impact mechanism housing 140 by a bushing 186. Alternatively, a roller bearing may be utilized in place of the bushing 186.

In operation of the tool 10, the motor support portion 48 is grasped by the user of the tool 10 during operation. Because of the positioning of the battery pack 54 relative to the motor 38 within the housing 34, the motor 38 and the battery pack 54 substantially fit within the envelope of the user's wrist to facilitate maneuverability of the tool 10 in small work spaces. Furthermore, the tool 10 may access small work spaces that would otherwise be inaccessible to conventional impact tools or impact wrenches.

During operation, the motor 38 rotates the drive shaft 142, through the transmission 44 and the bevel gear arrangement 156, in response to actuation of the trigger switch 60. The hammer 146 initially co-rotates with the drive shaft 142 and upon the first impact between the respective lugs 162, 172 of the hammer 146 and anvil 150, the anvil 150 and the output shaft 22 are rotated at least an incremental amount provided the reaction torque on the output shaft 22 is less than a predetermined amount that would otherwise cause the output shaft 22 to seize. However, should the reaction torque on the output shaft 22 exceed the predetermined amount, the output shaft 22 and anvil 150 would seize, causing the hammer 146 to momentarily cease rotation relative to the housing 140 due to the inter-engagement of the respective lugs 162, 172 on the hammer 146 and anvil 150. The shaft 142, however, continues to be rotated by the motor 38. Continued relative rotation between the hammer 146 and the shaft 142 causes the hammer 146 to displace axially away from the anvil 150 against the bias of the spring 178 in accordance with the geometry of the cam grooves 158, 166 within the respective drive shaft 142 and the hammer 146.

As the hammer 146 is axially displaced relative to the shaft 142, the hammer lugs 162 are also displaced relative to the anvil 150 until the hammer lugs 162 are clear of the anvil lugs 172. At this moment, the compressed spring 178 rebounds, thereby axially displacing the hammer 146 toward the anvil 150 and rotationally accelerating the hammer 146 relative to the shaft 142 as the balls 167 move within the pairs of cam grooves 158, 166 back toward their pre-impact position. The hammer 146 reaches a peak rotational speed, then the next impact occurs between the hammer 146 and the anvil 150. In this manner, the fastener, tool bit, and/or driver bit 20 received in the drive end 14 is rotated relative to a workpiece in incremental amounts until the fastener is sufficiently tight or loosened relative to the workpiece.

FIGS. 5-8 illustrate a second embodiment of an impact tool 10a, with like components as the impact tool 10 of FIGS. 1-4 being shown with like reference numerals with the letter “a”.

With reference to FIGS. 7 and 8, the impact tool 10a includes an actuation system 190 for automatically activating and deactivating the motor 38a without requiring the user to actuate a separate motor activation trigger. More particularly, the actuation system 190 activates the motor 38a in response to physical contact between the driver bit 20a and a workpiece (e.g., a fastener), and deactivates the motor 38a in response to removing physical contact between the driver bit 20a and the workpiece. In the illustrated embodiment of the impact tool 10a, the actuation system 190 includes a force sensor 194 in electrical communication with the motor 38a (e.g., via a high-level or master controller) and a linkage 198 extending between the force sensor 194 and the driver bit 20a for transferring force applied to the driver bit 20a to the force sensor 194.

As explained in more detail below, the force sensor 194 measures the magnitude of the applied force through the linkage 198 and outputs an associated control signal (e.g., via a high-level or master controller) to the motor 38a which, in the illustrated embodiment of the impact tool 10a, is configured as a variable speed motor 38a. Upon initial activation of the motor 38a in response to a force input detected by the sensor 194, the operating speed and/or output torque of the motor 38a may thereafter be varied in response to the measured force input to the force sensor. For example, as the force applied to the force sensor 194 is progressively increased, the operating speed and/or output torque of the motor 38a may also be progressively increased. Likewise, as the force applied to the force sensor 194 is progressively decreased, the operating speed and/or output torque of the motor 38a may also be progressively decreased. Such a force sensor is commercially available from Interlink of Camarillo, Calif. as part number FSR400. Alternatively, the motor 38a may be configured as a single speed and/or constant torque motor such that only an “on/off” signal needs to be supplied by the force sensor 194 to activate and deactivate the motor 38a, respectively.

As a further alternative, the actuation system 190 may include a potentiometer rather than the force sensor 194 for activating the motor 38a and varying a voltage applied to the motor 38a for either changing the operating speed and/or output torque of the motor 38a. In such an embodiment of the impact tool 10a, the linkage 198 may interface with the wiper of the potentiometer for rotating the wiper in response to displacement of the linkage 198.

With continued reference to FIGS. 7 and 8, the linkage 198 includes a first rod 202 proximate the driver bit 20a, a second rod 206 proximate the force sensor 194, and a biasing element 210 (e.g., a compression spring) positioned between the rods 202, 206. As shown in FIG. 8, the drive shaft 142a includes a stepped cylindrical bore 214 that progressively decreases in diameter from a first or upper end 148a of the drive shaft 142a to an opposite, second or lower end 152a of the drive shaft 142a. The first rod 202 is located in a first portion 218 of the stepped cylindrical bore 214, with a large-diameter end 222 of the first rod 202 being abutted with an internal shoulder 226 defining one of the steps in the stepped cylindrical bore 214, and a small-diameter end 230 of the first rod 202 protruding from the second end 152a of the drive shaft 142a. The small-diameter end 230 of the first rod 202 also extends partially through a stepped bore 234 within the anvil 150a and the output shaft 22a that is coaxial with the stepped bore 214 within the drive shaft 142a. In the illustrated embodiment of the impact tool 10a, the linkage 198 also includes a disk-like spacer 238 positioned between the small-diameter end 230 of the first rod 202 and the driver bit 20a. Like the large-diameter end 222 of the first rod 202, the spacer 238 is abutted with an internal shoulder 242 defining a step in the bore 234 within the anvil 150a, thereby limiting displacement of the spacer 238 between the second end 152a of the drive shaft 142a and the shoulder 242. Therefore, the abutment of the large-diameter end 222 of the first rod 202 with the shoulder 226, or the abutment of the small-diameter end 230 of the first rod 202 with the spacer 238, limits the extent to which the first rod 202 is displaceable toward the output shaft 22a. Alternatively, the spacer 238 may be omitted from the linkage 198, and the driver bit 20a may directly contact the small-diameter end 230 of the first rod 202 in response to a reaction force applied to the driver bit 20a as a result of contact with a workpiece.

With continued reference to FIG. 8, the second rod 206 is located in a second portion 246 of the stepped cylindrical bore 214, with a large-diameter end 250 of the second rod 206 being abutted with another internal shoulder 254 defining one of the steps in the bore 214, and a small-diameter end 258 of the second rod 206 protruding from the first end 148a of the drive shaft 142a and proximate the force sensor 194. The drive shaft 142a includes an annular retainer 262 that is interference fit within the bore 214 adjacent the second end 152a of the drive shaft 142a for maintaining the second rod 206 coaxial with the bore 214. The actuation system 190 further includes another biasing element 266 (e.g., a compression spring) positioned between the retainer 262 and the large-diameter 250 end of the second rod 206 for biasing the small-diameter end 258 of the second rod 206 away from the force sensor 194.

In an alternative embodiment of the impact tool 10a, the multi-piece linkage 198 may be replaced with a single piece linkage configured as a contiguous rod having a first end engageable with the driver bit 20a and a second end proximate the force sensor 194.

With reference to FIGS. 7 and 8, the impact tool 10a also includes an illumination assembly 270 configured to illuminate the workpiece during operation of the impact tool 10a. In the illustrated embodiment of the impact tool 10a, the illumination assembly 270 includes a light 274 (e.g., an LED) positioned within a translucent cover 278 proximate the output shaft 22a for illuminating the workpiece. With reference to FIG. 7, the illumination assembly 270 also includes a switch 282 for selectively electrically connecting the light 274 to the battery 54a. The switch 282 includes an actuator portion or a button 286 that is located on the sidewall 64a of the housing 34a at least partially between the motor axis 55a and the battery axis 56a, as shown in FIG. 6, to facilitate actuation of the switch 282 by the user's thumb while the motor support portion 48a is grasped by the user's palm. Alternatively, the button 286 may be located elsewhere on the housing 34a, or the switch 282 may be omitted in lieu of simultaneous activation and deactivation of the light 274 with the motor 38a by the actuation assembly 190.

The impact tool 10a further includes a direction switch 68a (FIGS. 5 and 6) that is manually toggled between a first position, in which the motor 38a is activated to rotate the output shaft 22a in a forward (i.e., clockwise) direction, and a second position, in which the motor 38a is activated to rotate the output shaft 22a in a reverse (i.e., counter-clockwise) direction.

In operation of the impact tool 10a, the actuation system 190 is operable to automatically activate the motor 38a in response to depressing the driver bit 20a against a workpiece, thereby obviating the need for a separate, manually actuated motor activation switch. Specifically, in response to a reaction force applied to the driver bit 20a, the driver bit 20a is displaced upward from the frame of reference of FIG. 8 to contact the spacer 238. Upon contacting the spacer 238, both the spacer 238 and the first rod 202 are displaced upward, thereby unseating the large-diameter end 222 of the first rod 202 from the shoulder 226 and compressing the spring 210. Once the magnitude of the reaction force exceeds the force exerted by the spring 266, the large-diameter end 250 of the second rod 206 is unseated from the shoulder 254 and the small-diameter end 258 of the second rod 206 is displaced toward the force sensor 194. Thereafter, the small-diameter end 258 of the second rod 206 either directly or indirectly applies a force to the force sensor 194 which, in turn, generates a control signal (via a high-level or master controller, as previously described) for activating the motor 38a. Optionally, as the force applied to the force sensor 194 is progressively increased (i.e., in response to a progressively increasing reaction force applied to the driver bit 20a), the control signal may cause the operating speed and/or output torque of the motor 38a to also be progressively increased for performing work on the workpiece at an increased rate or delivering an increased amount of torque to the workpiece. Once the motor 38a is activated, the operation of the impact tool 10a is otherwise identical to that described above in connection with the impact tool 10 of FIGS. 1-4.

Likewise, decreasing the applied force on the force sensor 194 causes the force sensor 194 to generate a control signal to reduce the operating speed and/or output torque of the motor 38a. Further, removing the applied force from the force sensor 194 causes the force sensor 194 to generate a control signal to deactivate the motor 38a.

Although the actuation system 190 is described and illustrated in connection with the impact tool 10a, it may also be incorporated in a non-impact rotary power tool (e.g., a driver drill).

FIGS. 9 and 10 illustrate a third embodiment of an impact tool 10b, with like components as the impact tool 10a of FIGS. 5-8 being shown with like reference numerals with the letter “b”.

With reference to FIGS. 9 and 10, the impact tool 10b includes an actuation system 290 for automatically activating and deactivating the motor 38b, without requiring the user to actuate a separate motor activation trigger, in response to the presence or absence of physical contact between the driver bit 20b and a workpiece (e.g., a fastener), respectively. The actuation system 290 includes a microswitch 302, a linkage 294, and a magnet assembly 296 positioned between the microswitch 302 and the linkage 294 (FIG. 9). The magnet assembly 296 includes a housing 298 attached to the linkage 294 for displacement therewith and a torsion spring 306 mounted to the housing 298. The torsion spring 306 includes an arm 308 that is engageable with the microswitch 302 for actuating the microswitch 302 which, in the illustrated embodiment of the actuation system 290, is normally open. With continued reference to FIG. 9, the actuation system 290 also includes a Hall-effect sensor 310 in electrical communication with the motor 38b (e.g., via a high-level or master controller). The Hall-effect sensor interfaces with a magnet 314 mounted in the housing 298 of the magnet assembly 296, of which the magnet 314 is also a component. As explained in more detail below, the linkage 294 is capable of displacing the magnet assembly 296 toward the Hall-effect sensor 310, therefore causing the arm 308 of the torsion spring 306 to engage and actuate the microswitch 302. Following actuation of the microswitch 302, a continued application of force applied to the driver bit 20a reduces the gap between the Hall-effect sensor 310 and the magnet 314.

The Hall-effect sensor 310 measures a proximity of the magnet 314 and outputs an associated control signal (e.g., via a high-level or master controller) to the motor 38b which, in the illustrated embodiment of the impact tool 10b, is configured as a variable speed motor 38b. Upon initial activation of the motor 38b in response to the microswitch 302 being actuated, the operating speed and/or output torque of the motor 38a may thereafter be varied in response to the proximity of the magnet 314 to the Hall-effect sensor 310. For example, as the linkage 294 displaces the magnet 314 progressively closer to the Hall-effect sensor 310, therefore decreasing a distance between the magnet 314 and the Hall-effect sensor 310, the operating speed and/or output torque of the motor 38b may be progressively increased. Likewise, as the distance between the magnet 314 and the Hall-effect sensor 310 is progressively increased, the operating speed and/or output torque of the motor 38a may be progressively decreased.

With reference to FIGS. 9 and 10, the linkage 294 includes a rod 318 having a first end 322 proximate the driver bit 20b and a second end 326 attached to the magnet assembly 296. As shown in FIG. 10, the rod 318 is located within the stepped cylindrical bore 214b, and includes a shoulder or flange 330 between the first end 322 and second end 326. The flange 330 of the rod 318 abuts the internal shoulder 226b that defines one of the steps in the stepped cylindrical bore 214b. The first end 322 of the rod 318 protrudes from the second end 152b of the drive shaft 142b and extends partially through the stepped bore 234b of the anvil 150b. The linkage 294 also includes the disk-like spacer 238b positioned between the first end 322 of the rod 318 and the driver bit 20b. Like the flange 330 of the rod 318, the spacer 238b is abutted with an internal shoulder 242b defining a step in the bore 234b within the anvil 150b, thereby limiting displacement of the spacer 238 between the second end 152b of the drive shaft 142b and the shoulder 242b. Therefore, the abutment of the flange 330 of the rod 318 with the shoulder 226b, or the abutment of the first end 322 of the rod 318 with the spacer 238b, limits the extent to which the rod 318 is displaceable toward the output shaft 22b. Alternatively, the spacer 238b may be omitted from the linkage 294, and the driver bit 20b may directly contact the first end 322 of the rod 318 in response to a reaction force applied to the driver bit 20b as a result of contact with a workpiece.

With continued reference to FIG. 10, the second end 326 of the rod 318 protrudes from the first end 148b of the drive shaft 142a and is attached to the magnet assembly 296. The rod 318 is maintained coaxial within the bore 214b by the annular retainer 262b that is adjacent the first end 148b of the drive shaft 142a. The actuation system 290 further includes a biasing element 334 (e.g., a compression spring) positioned between the retainer 262b and the flange 330 of the rod 318 for biasing the second end 326 of the rod 318 and the magnet 314 away from the Hall-effect sensor 310.

In operation of the impact tool 10b, the actuation system 290 is operable to automatically activate the motor 38b in response to depressing the driver bit 20b against a workpiece. Specifically, in response to a reaction force applied to the driver bit 20b, the driver bit 20b is displaced upward from the frame of reference of FIG. 10 to contact the spacer 238b. Upon contacting the spacer 238b, both the spacer 238b and the rod 318 are displaced upward, thereby unseating the flange 330 from the shoulder 242b and compressing the spring 334. The magnet assembly 296 is also displaced upward with the rod 318, causing the arm 308 of the torsion spring 306 to contact and actuate the microswitch 302, which closes the microswitch 302. Closing the microswitch 302 completes a circuit in the high-level or master controller, which then generates a control signal to initially activate the motor 38b. After the motor 38b is activated and the reaction force applied to the driver bit 20b is progressively increased, the magnet 314 (which is attached to the second end 326 of the rod 318 through the housing 298) is displaced closer to the Hall-effect sensor 310. As the gap between the Hall-effect sensor 310 and the magnet 314 is decreased, the control signal output by the high-level or master controller is varied to cause the operating speed and/or output torque of the motor 38b to be progressively increased. Following actuation of the microswitch 302, continued displacement of the magnet 314 toward the Hall-effect sensor 310 also causes the torsion spring arm 308 to deflect relative to the housing 298, thereby providing a biasing force against the linkage 294 in addition to the biasing force provided by the spring 334.

Likewise, decreasing the reaction force applied to the driver bit 20b displaces the second end 326 of the rod 318 and the magnet 314 away from the Hall-effect sensor 310 as the spring 334 biases the rod 318 downward, causing the high-level or master controller to output a control signal for reducing the operating speed and/or output torque of the motor 38b. Further, removing the driver bit 20b from the workpiece causes the magnet assembly 296, and therefore the torsion spring 306, to be biased away from microswitch 302. Upon being disengaged by the torsion spring 306, the microswitch 302 resumes an open state, thereby opening a circuit in the high-level or master controller to deactivate the motor 38b.

Although the actuation system 290 is described and illustrated in connection with the impact tool 10b, it may also be incorporated in a non-impact rotary power tool (e.g., a driver drill).

Various features of the invention are set forth in the following claims.

What is claimed is:

1. An impact tool comprising:
a housing,
a motor supported in the housing and defining a first axis;
an output shaft rotatably supported in the housing about a second axis oriented substantially normal to the first axis;
an impact mechanism coupled between the motor and the output shaft and operable to impart a striking force in a rotational direction to the output shaft; and
a battery electrically connected to the motor and oriented along a third axis substantially parallel with and offset from the first axis.

2. The impact tool of claim 1, wherein at least a portion of the battery axially overlaps the motor in a direction along the first and third axes.

3. The impact tool of claim 1, further comprising:
a light configured to illuminate a workpiece; and
a switch for selectively electrically connecting the light to the battery, wherein the switch is located at least partially between the first and third axes.

4. The impact tool of claim 1, wherein the housing includes a motor support portion in which the motor is contained, and wherein the motor support portion is grasped by a user of the impact tool during operation.

5. The impact tool of claim 4, wherein the battery is coupled to a battery support portion of the housing.

6. The impact tool of claim 5, wherein the battery is removably coupled to the battery support portion of the housing along the third axis.

7. The impact tool of claim 1, wherein the impact mechanism includes
an anvil rotatably supported in the housing, and
a hammer coupled to the motor to receive torque from the motor and impart the striking force in the rotational direction to the anvil.

8. The impact tool of claim 7, wherein the anvil and the hammer are each rotatable about the second axis.

9. The impact tool of claim 7, wherein the anvil is integrally formed with the output shaft as a single piece.

10. The impact tool of claim 9, wherein the impact mechanism further includes
a drive shaft having a first cam groove, and
a cam member at least partially received within the first cam groove and a second cam groove within the hammer, wherein the cam member imparts axial movement to the hammer relative to the drive shaft in response to relative rotation between the drive shaft and the hammer.

11. The impact tool of claim 10, further comprising a bevel gear arrangement coupled between the motor and the drive shaft, wherein the bevel gear arrangement includes a first bevel gear coupled for co-rotation with the drive shaft and a second bevel gear engaged with the first bevel gear.

12. The impact tool of claim 11, wherein the second bevel gear is coaxial with the first axis.

13. The impact tool of claim 11, further comprising a planetary transmission coupled between the motor and the second bevel gear.

14. The impact tool of claim 11, wherein the impact mechanism further includes a resilient member coupled between the hammer and the first bevel gear for biasing the hammer toward the anvil.

15. The impact tool of claim 1, further comprising:
a sensor electrically connected with the motor for activating the motor; and
a linkage extending between the sensor and a tool bit coupled to the output shaft, wherein the sensor is operable to detect a force input from the linkage, or proximity of the linkage, in response to the tool bit being depressed against a workpiece to activate the motor.

16. The impact tool of claim 15, wherein operating speed and/or output torque of the motor is variable.

17. The impact tool of claim 16, wherein, in response to a progressively increasing force applied to the sensor by the linkage, or a progressively nearing proximity of the linkage to the sensor, the operating speed and/or output torque of the motor is progressively increased.

18. The impact tool of claim 15, wherein the linkage extends through the output shaft.

19. The impact tool of claim 18, wherein the linkage includes
a first rod proximate the tool bit,
a second rod proximate the sensor, and
a biasing element positioned between the first rod and the second rod.

20. The impact tool of claim 19, wherein the biasing element is a first biasing element, and wherein the impact tool further comprises a second biasing element exerting a biasing force against the linkage in a direction away from the sensor.
